(19) United States
(12) Patent Application Publication
(10) Pub. No.: US 2015/0165657 A1
(43) Pub. Date: Jun. 18, 2015

(54) APPARATUS FOR FORMING PANELS

(71) Applicant: Euretech International Pty Ltd., Maroochydore (AU)

(72) Inventor: Tonny Ernst Bergqvist, Kunda Park (AU)

(21) Appl. No.: 14/404,533

(22) PCT Filed: May 29, 2013
(86) PCT No.: PCT/AU2013/000569

§ 371 Date: Nov. 28, 2014

(30) Foreign Application Priority Data
May 30, 2012 (AU) 2012902249

(51) Int. Cl. B29C 44/12; B29C 33/20

(52) U.S. Cl. CPC B29C 44/1233; B29C 33/20; B29K 2075/00

(57) ABSTRACT

An apparatus (10) and method for forming panels, preferably polyurethane foam core building panels. The apparatus includes opposed frame members (12, 14) movable relative to one another. A locking assembly (100) is provided that locks the frame members (12, 14) in a closed position using a hydraulic cylinder (110) with a locking member (112) on one of the frame members and a lock receiving portion (120), on the other of the frame members, that receives the locking member (112). The frame members (12, 14) are retained in the closed position by the locking assembly (100), and can be subsequently opened by actuating the hydraulic cylinder (110) to release the locking assembly (100).

### FIELD OF THE INVENTION

The invention primarily relates to an apparatus for forming panels. In particular, the invention relates, but is not limited, to an apparatus for manufacturing insulated modular building panels having a liquid foamable polyurethane resin core.

### BACKGROUND TO THE INVENTION

Reference to background art herein is not to be construed as an admission that such art constitutes common general knowledge in Australia or elsewhere.

The construction and use of insulated panels, particularly in situations where thermal insulation is desirous, is known. Such panels typically have cellular cores sandwiched between durable outer layers. The outer layers are typically sheet or corrugated metal, but may be made of any suitable material, such as plastic or timber.

One method of forming such panels is to place two outer ‘skin’ layers in a press module. The skin layers are placed on opposed plates of the press module and seals are placed around the perimeter of one of the panels. The press module is then closed to a position where the skin layers are held in substantially parallel planes. The seals keep the skin layers spaced apart while also sealing the perimeter of the panels, defining a cavity between the skin layers.

The press module is then locked by tightening locking assemblies such that the plates are held rigidly in the closed position. A liquid foamable material, such as liquid foamable polyurethane foam, is injected into the cavity through one or more conduits in the seal. The polyurethane foam expands in the cavity, filling the cavity and bonding the two skin layers together.

As the polyurethane foam expands, significant pressure is exerted on the plates of the press module. It is therefore imperative that the locking assemblies are tightened sufficiently to rigidly hold the plates under the high pressure environment. Once the polyurethane foam has expanded and cured, the press module is unlocked and opened. The panel, including both skin layers and polyurethane foam core, is then removed.

While this process makes satisfactory panels, it is very labour intensive. In particular, the locking of the plates requires one or more operators to manually tighten the locking assemblies. In order to withstand the high pressures during expansion and curing of the polyurethane foam there are a lot of locking assemblies. This process not only requires sufficient operators to be on hand to lock, and subsequently unlock, the press module, but is also time consuming, with the locking and unlocking of the locking assemblies taking a significant portion of the time taken to form a panel.

An additional problem is human error that is occurs when the locking assemblies, which include an acme screw threaded clamp, are under or over tightened. If a locking assembly is under-tightened then this can lead to the liquid foamable material leaking. This typically renders the panel unusable in addition to contaminating the workplace with the injection material. On the other hand, over-tightening of the locking assemblies can increase the time taken to loosen the locking assemblies and, in some cases, causes damage to the locking assembly and/or press module.

### OBJECT OF THE INVENTION

It is an aim of this invention to provide an apparatus for forming panels which overcomes or ameliorates one or more of the disadvantages or problems described above, or which at least provides a useful alternative.

Other preferred objects of the present invention will become apparent from the following description.

### SUMMARY OF INVENTION

According to a first aspect of the invention, there is provided an apparatus for forming panels, the apparatus comprising:

a pair of opposed frame members movable relative to one another between at least an open position and a closed position, wherein in the closed position the pair of opposed frame members are adjacent and in substantially parallel planes; and

at least one locking assembly that selectively retains the frame members in the closed position, wherein the locking assembly comprises:
a fluid actuated piston mounted on one of the frame members, the fluid actuated piston having a locking member; and
a lock receiving portion mounted on the other of the frame members, the lock receiving portion being shaped to receive the locking member of the fluid actuated piston,

wherein the frame members are retained in the closed position by the locking member of the fluid actuated piston being received by the lock receiving portion.

Preferably the fluid actuated piston is a hydraulic cylinder. Preferably the hydraulic cylinder has a check valve to maintain pressure on the locking member even if power to a hydraulic circuit powering the hydraulic cylinder is cut. Preferably the check valve is a pilot check valve. Preferably, the hydraulic cylinder is extended when the locking assembly is in an unlocked position and is retracted when the locking assembly is in a locked position.

Preferably the locking member is a locking pin. Preferably the locking pin is mounted on one or more fingers of the fluid actuated piston. The lock receiving portion is preferably a boss. The boss preferably has a recess that receives the locking pin when the locking assembly is in the locked position.

Preferably the opposed frame members are hinged. Preferably a hinge between the opposed frame members is located on an opposite side of the frame members to the locking assembly. Preferably a plurality of locking assemblies are provided which are, preferably, aligned along a length of the apparatus. Preferably the locking assemblies are aligned longitudinally along the length of the apparatus. The plurality of locking assemblies are preferably configured to be actuated substantially simultaneously.

According to a second aspect of the invention, there is provided a method of locking an apparatus for forming panels to retain the apparatus in a closed position, the method comprising the steps of:

positioning a pair of opposed frame members adjacent each other in the closed position;

actuating a fluid actuated piston mounted on one of the frame members, the fluid actuated piston having a locking member that is moved during actuation of the piston; and

receiving the locking member of the fluid actuated piston within a lock receiving portion mounted on the other of the frame members.

According to a third aspect of the invention, there is provided a method of forming a panel using an apparatus for forming panels, the method comprising the steps of:

arranging the apparatus in an open position;

locating a first skin layer on a first frame member of the apparatus;

locating a second skin layer on a second frame member of the apparatus, wherein the second frame member is movably opposed to the first frame member between the open and a closed position;

locating one or more seals around the perimeter of the first and second skin layers;

arranging the apparatus in the closed position, wherein the first skin layer and second skin layer each abut the one or more seals to define a cavity therein;

locking the apparatus in the closed position by actuating a fluid actuated piston mounted on one of the frame members, the fluid actuated piston having a locking member that is moved during actuation of the piston, and receiving the locking member of the fluid actuated piston within a lock receiving portion mounted on the other of the frame members;

injecting a liquid foamable material into the cavity through at least one conduit in the one or more seals;

allowing the liquid foamable material to cure;

unlocking the apparatus by actuating the fluid actuated piston such that the locking member is removed from the lock receiving portion;

moving the apparatus at least partially to the open position; and

removing the panel which includes the first skin layer, second skin layer, and a foam core derived from the cured liquid foamable material.

Preferably the apparatus used in the methods is an apparatus for forming panels as previously described.

Preferably the fluid actuated piston is a hydraulic cylinder and actuation of the hydraulic cylinder causes the cylinder to extend or retract. Preferably the locking member is a locking pin which is moved to be received by a recess of the lock receiving portion when the hydraulic cylinder is retracted, and is moved out of the recess of the lock receiving portion when the hydraulic cylinder is extended.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates a front elevation view of an apparatus for forming panels;

FIG. 2 illustrates a plan view of the apparatus for forming panels shown in FIG. 1;

FIG. 3 illustrates an end elevation view of the apparatus for forming panels shown in FIG. 1;

FIG. 4A illustrates a cross sectional view of a portion of an apparatus for forming panels in a partially open position;

FIG. 4B illustrates the apparatus shown in FIG. 4a in an unlocked closed position;

FIG. 4C illustrates the apparatus shown in FIG. 4a in a locked closed position;

FIG. 5A illustrates a close up view of a locking assembly portion of FIG. 4a;

FIG. 5B illustrates a close up view of a locking assembly portion of FIG. 4b;

FIG. 5C illustrates a close up view of a locking assembly portion of FIG. 4c;

FIG. 6A illustrates a plan view of the locking assembly portion in the position shown in FIG. 5B and

FIG. 6B illustrates a plan view of the locking assembly portion in the position shown in FIG. 5C.

### DETAILED DESCRIPTION OF THE DRAWINGS

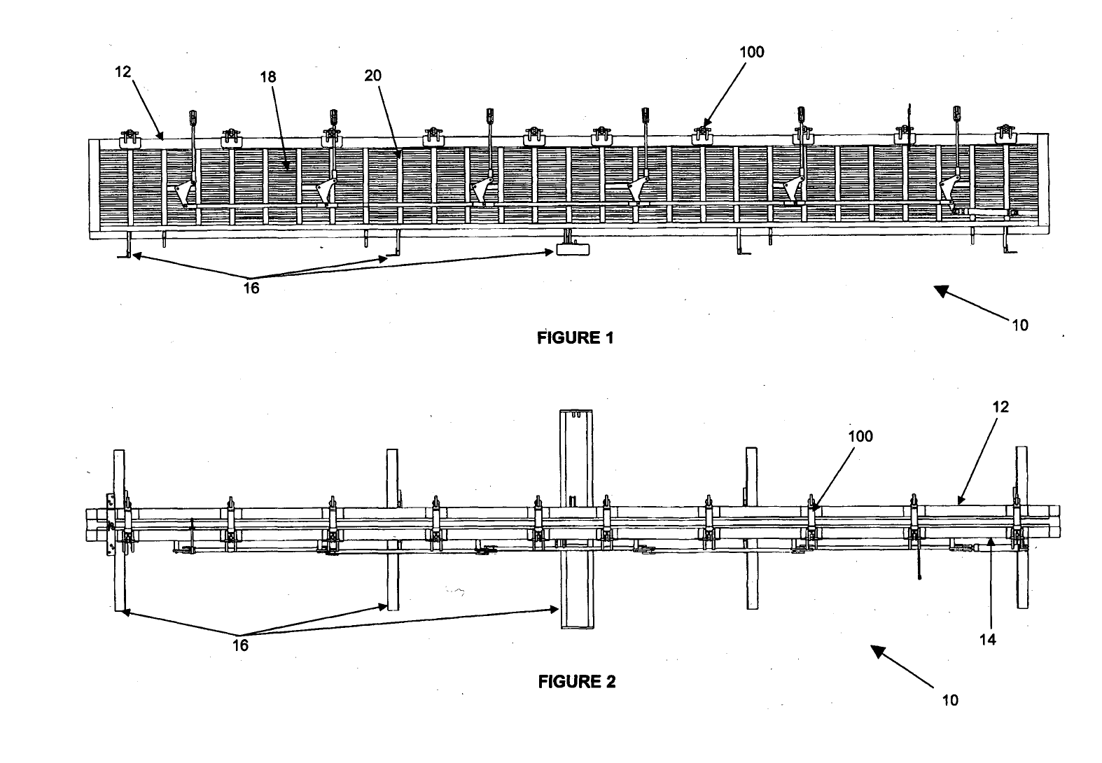

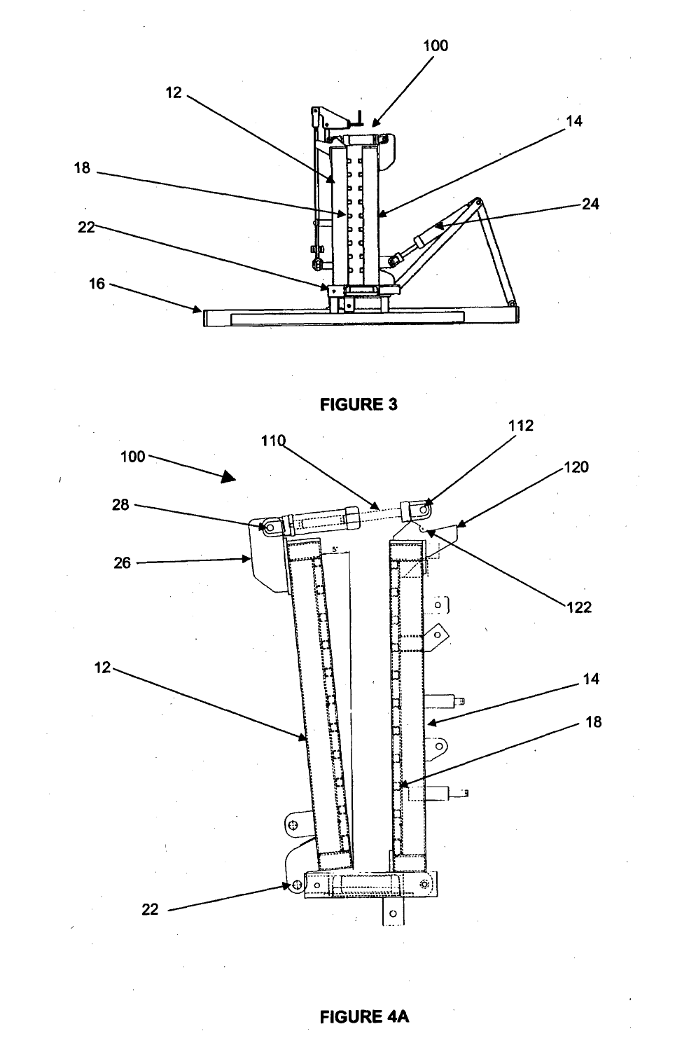

FIGS. 1 to 3 illustrate a panel forming apparatus 10 including a pair of opposed frame members 12 and 14 (see FIGS. 2 and 3). The panel forming apparatus 10 has an open and a closed position, and is illustrated in FIGS. 1 to 3 in the closed position where the frame members 12 and 14 are adjacent and in substantially parallel planes.

The panel forming apparatus 10 has base members 16 which are substantially perpendicular to the frame members 12 and 14 when they are in the closed position (as illustrated). Each frame member 12, 14 has a plurality of longitudinal bars 18 and reinforcing ribs 20. The longitudinal bars 18 and reinforcing ribs 20 are formed of metal box tubing.

The longitudinal bars 18 are typically spaced to accommodate the peaks and troughs of a profiled outer skin layer in the form of a sheet (not shown), such as a corrugated sheet metal. Alternatively the inner surface of each frame member 12, 14 may be shaped or arranged to accommodate different outer skin sheet profiles, including substantially planar surfaces for substantially planar outer skin sheets.

The frame members 12 and 14 are hinged and movable relative to each other about hinge 22 (see FIG. 3). This enables the frame members 12 and 14 to open at an angle to each other to the open position. In the open position the components of a panel to be formed can be placed in the apparatus 10 and formed panels can subsequently be removed from the apparatus 10. The apparatus has a lower hydraulic cylinder 24 that can be actuated to move the frame members between the open position and the closed position.

The apparatus 10 has a plurality of locking assemblies 100. The locking assemblies 10 are aligned along the length of the apparatus 10. It will be appreciated that the number of locking assemblies 100 will generally vary depending on the length of the apparatus 10. As shown in FIGS. 1 and 2 the illustrated apparatus 10 has ten locking assemblies 100.

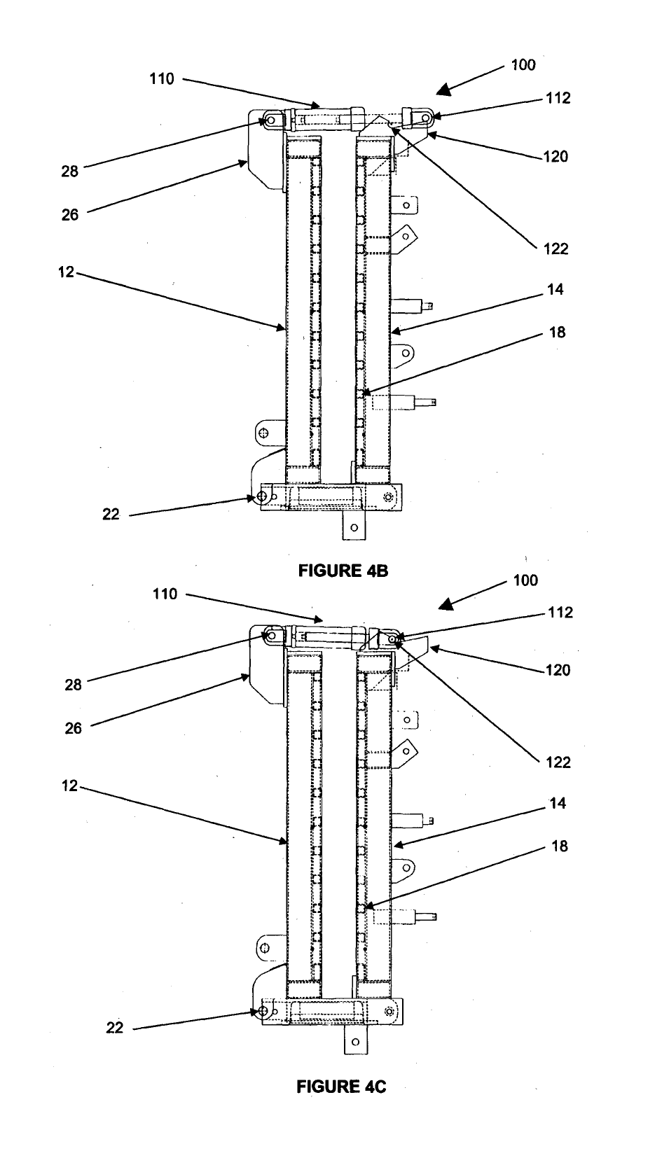

FIGS. 4A to 4C illustrate a cross-sectional view showing frame members 12 and 14 in a partially open position (FIG. 4A) and in the closed position (FIGS. 4B and 4C), as well as showing the locking assembly 100 in an unlocked position (FIGS. 4A and 4B) and in a locked position (FIG. 4C) in which it retains the frame members 12 and 14 in the closed position. Turning specifically to FIG. 4A, frame member 12 is angled relative to frame member 14 about hinge 22. The position shown in FIG. 4A is only partially open, with the frame members 12 and 14 being positioned at a greater angle to each other in the fully open position (not shown).

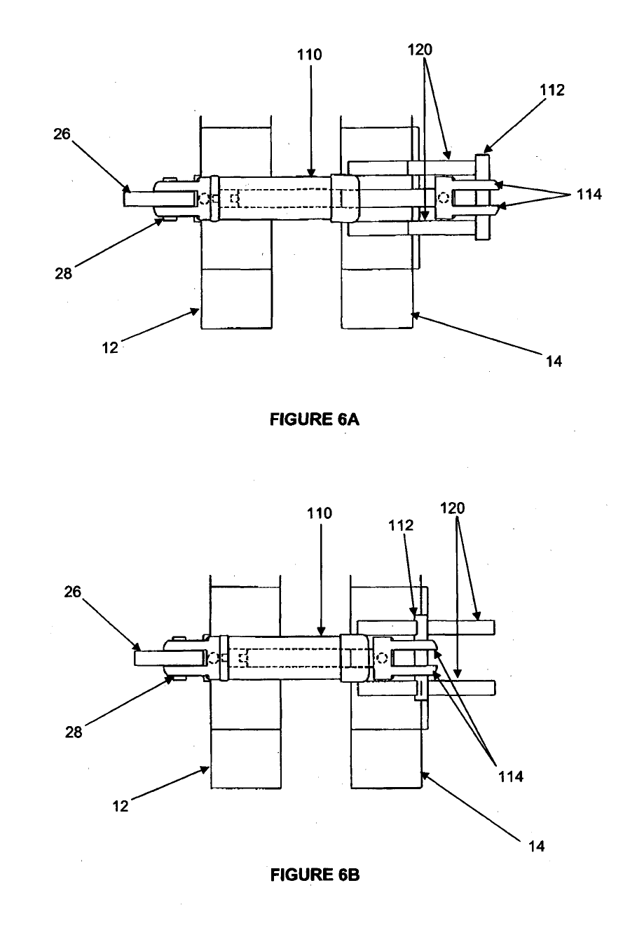

Locking assembly 100 is shown more clearly in FIGS. 4A to 4C and includes a fluid actuated piston in the form of a hydraulic cylinder 110 with a locking member 112 mounted thereon. As seen most clearly in FIGS. 6A and 6B, the locking member is in the form of a locking pin 112 which is mounted perpendicularly to fingers 114 of the hydraulic cylinder 110. The hydraulic cylinder is mounted on a buttress 26 of one of the frame members 12. The hydraulic cylinder is preferably movably mounted, such that it can rotate about a retainer 28 that is held by the buttress 26.

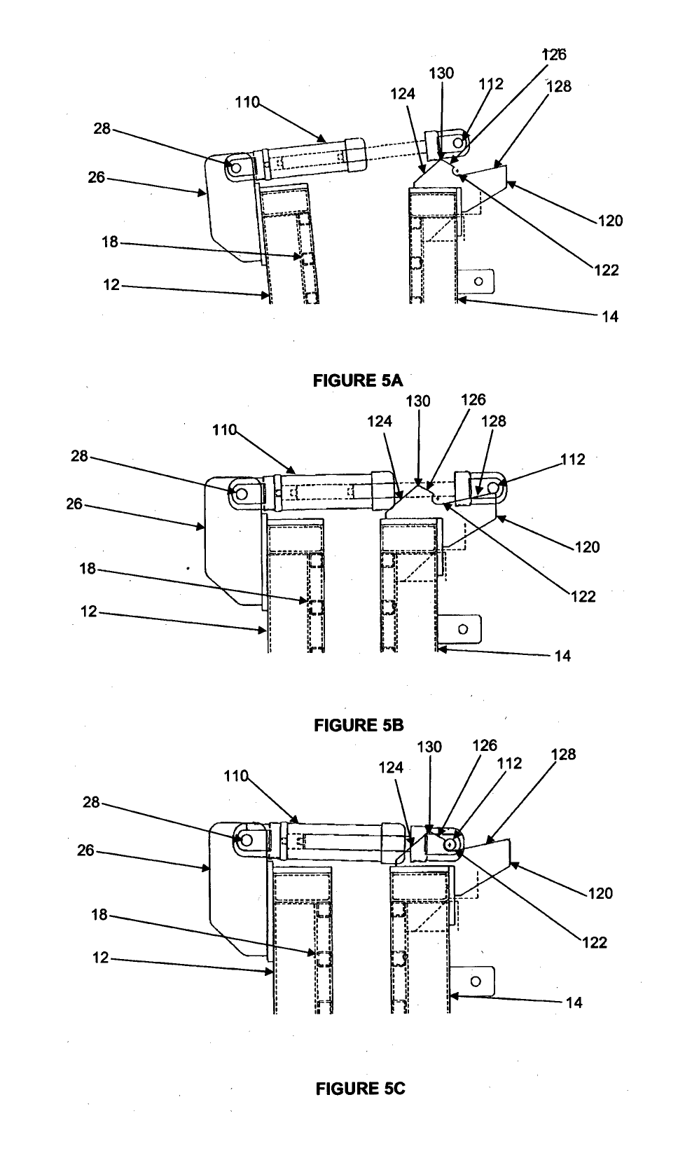

The locking assembly 100 also includes a lock receiving portion in the form of a boss 120. As seen most clearly in FIGS. 6A and 6B, the boss 120 has two plates spaced apart to allow the fingers 114 of the hydraulic cylinder 110 to be received therebetween. The boss 120 is shaped and has a recess 122 as will be discussed in more detail in relation to FIGS. 5A to 5C.

FIG. 4A illustrates the frame members 12 and 14 in the partially open unlocked position, where the hydraulic cylinder 110 is extended and the locking pin 112 is clear of the boss 120 allowing the frame members 12 and 14 to be freely moved relative to each other. FIG. 4B illustrates the frame members 12 and 14 in the closed position, where the frame members 12 and 14 are in parallel planes. In this position the hydraulic cylinder 110 is still extended and the locking pin 112 rests on boss 120, but is not received in the recess 122.

FIG. 4C illustrates the frame members 12 and 14 in the closed position but with the locking assembly 100 locked. The hydraulic cylinder is retracted to a locked position which locates the locking pin 112 in the recess 122 of the boss 120. The locking pin 112 is held by the hydraulic cylinder 110 in the recess 122 which, in combination, locks the frame members 12 and 14 in the closed position (as shown in FIG. 4C).

Hydraulic cylinder 110 has a check valve (not shown) to allow it to retain pressure even if power to a hydraulic circuit powering the hydraulic cylinder is cut. The check valve is preferably a pilot check valve to enable the check valve to be disabled.

FIGS. 5A to 5C, in conjunction with FIGS. 6A and 6B, show the locking assembly 100 in more detail. FIGS. 5A to 5C correspond to FIGS. 4A to 4C, respectively; and FIGS. 6A and 6B correspond to FIGS. 5B and 5C, respectively. As seen most clearly in FIG. 5A, boss 120 is shaped with various angled surfaces arranged to allow the locking pin 112 to pass over the boss 120 during opening and closing of the apparatus 10, while also allowing the locking pin 112 to be received in and removed from the recess 122 when the locking assembly 100 is actuated.

The boss 120 has a first angled surface 124, second angled surface 126 and a third angled surface 128. From left to right, the first angled surface is angled upwards, the second angled surface is angled downwards, and the third angled surface is angled upwards, but at an incline which is generally less than the incline of the first angled surface. The recess 122 is located at the junction of the second and third angled surfaces.

As the frame members 12 and 14 are moved from the open position to the closed position (FIG. 5A showing a partially open position) the locking pin 112 has to clear the top of the boss 120. If the locking pin 112 is sitting slightly lower than the peak 130 of the locking pin, then the first angled surface 124 is inclined to allow the locking pin 112 to traverse the side of the boss 120 to the peak. The locking pin 112 can then traverse the second angled surface 126 to rest on the third angled surface 128, where it shown in FIG. 5B.

As the hydraulic cylinder 110 is actuated it moves from an extended position, as shown in FIGS. 5A, 5B, and 6A, to a retracted position, as shown in FIGS. 5C and 6B. As the hydraulic cylinder 110 retracts the locking pin 112 slides down the third angled surface 128 to the recess 122. The recess 122 is shaped to engage the locking pin 112 and prevent it from being able to traverse the second angled surface 126 after sliding down the third angled surface 128. With the hydraulic cylinder 110 in the retracted position, preferably locked by a check valve, the frame members 12 and 14 of the apparatus 10 are retained in the closed position.

To move the frame members 12 and 14 to the open position, the hydraulic cylinder 110 is actuated and extends to an extended position, as shown in FIGS. 5B and 6A. As the hydraulic cylinder 110 extends the locking pin 112 slides up the third angled surface 128. The frame members 12 and 14 can then be moved relative to each other, as shown in FIG. 5A. The angular movement of frame member 12 relative to frame member 14 effectively lifts the locking pin 112 of the hydraulic cylinder 110 over the peak 130 of the boss 120. Should the locking pin 112 sit lower than the peak 130 of the boss 120, then it will traverse the second angled surface 126 upwards until the locking pin 112 is able to clear the peak 130.

In use, the apparatus 10 is utilised to form panels (not shown) comprising two opposed skin layers sandwiching a foam Core. The apparatus 10 is first placed in the open position and a first and second skin layer are each located on one of the frame members 12 and 14. A seal is placed around the perimeter of one of the skin layers. Typically the seal comprises four individual seals, one for each side of the skin layer.

The apparatus 10 is then closed by actuating the lower hydraulic cylinder 24 to move the frame members 12 and 14 to the closed position. In the closed position the first and second skin layers are disposed adjacent in parallel planes abutting the seals around the perimeter which provide a predetermined distance between the two layers. The skin layers and seals together define a cavity.

The locking assembly 100 is then moved from an unlocked position, as shown in FIGS. 4B, 5B, and 6A to a locked position, as shown in FIGS. 4C, 5C, and 6B, as described previously. Namely, the hydraulic cylinder 110 of the locking assembly 100 is actuated which moves the locking pin 112 into the recess 122 of boss 120. In the closed and locked position the frame members are rigidly retained in position.

A liquid foamable material, preferably liquid foamable polyurethane, is then injected into the cavity through a conduit in the seals. The liquid foamable material expands, filling the cavity with foam. As the liquid foamable material expands and cures, significant forces are exerted on the frame members 12 and 14. The locking assembly 100 ensures that the frame members 12 and 14 are retained in position and do not move apart.

Once the liquid foamable material has cured the locking assembly 100 is unlocked by actuating the hydraulic cylinder 110 to extend such that the locking pin 112 is removed from the recess 122 of the boss 120, as shown in FIGS. 4B, 5B, and 6A. The frame members 12 and 14 can then be moved to the open position, or at least partially towards the open position, to allow the newly formed panel to be removed from the apparatus 10.

Advantageously, the invention provides an automated locking assembly that is not only secure, but significantly quicker and less labour intensive than previous locking systems. Additionally, the apparatus 10 is easier to use and as there is no manual handling of locking components, such as previously used acme screw threaded locks, the frame members 12 and 14 of the apparatus 10 are consistently locked in the same manner to the same pressures. This prevents any damage occurring to the apparatus 10, and also minimises potential for operator injury. Furthermore, the pilot check valve ensures that the hydraulic cylinder remains locked, even in the event of power failure, or the like, which otherwise could release the locking mechanism prematurely.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments' that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. An apparatus for forming panels, the apparatus comprising:
a pair of opposed frame members movable relative to one another between at least an open position and a closed position, wherein in the closed position the pair of opposed frame members are adjacent and in substantially parallel planes; and
at least one locking assembly that selectively retains the frame members in the closed position, wherein the locking assembly comprises:
a fluid actuated piston mounted on one of the frame members, the fluid actuated piston having a locking member; and
a lock receiving portion mounted on the other of the frame members, the lock receiving portion being shaped to receive the locking member of the fluid actuated piston,
wherein the frame members are retained in the closed position by the locking member of the fluid actuated piston being received by the lock receiving portion.

2. The apparatus of claim 1, wherein the fluid actuated piston is a hydraulic cylinder.

3. The apparatus of claim 2, wherein the hydraulic cylinder has a check valve to maintain pressure on the locking member.

4. The apparatus of claim 2 or 3, wherein the hydraulic cylinder is extended when the locking assembly is in an unlocked position and is retracted when the locking assembly is in a locked position.

5. The apparatus of any one of the preceding claims, wherein the locking member is a locking pin.

6. The apparatus of claim 5, wherein the locking pin is mounted on one or more fingers of the fluid actuated piston.

7. The apparatus of claim 5 or 6, wherein the lock receiving portion is a boss with a recess configured to receive the locking pin when the locking assembly is in, the locked position.

8. The apparatus of any one of the preceding claims, wherein the opposed frame members are hinged by a hinge between the opposed frame members that is located on an opposite side of the frame members to the locking assembly.

9. The apparatus of any one of the preceding claims, wherein each frame member comprises a plurality of longitudinal bars and reinforcing ribs.

10. The apparatus of claim 9, wherein the longitudinal bars are spaced to accommodate the peaks and troughs of a profiled outer skin layer.

11. The apparatus of any one of the preceding claims wherein a plurality of locking assemblies are provided.

12. The apparatus of claim 11, wherein the plurality of locking assemblies are aligned along a length of the apparatus.

13. The apparatus of claim 11 or 12, wherein the plurality of locking assemblies are configured to be actuated substantially simultaneously.

14. A method of locking an apparatus for forming panels to retain the apparatus in a closed position, the method comprising the steps of:
positioning a pair of opposed frame members adjacent each other in substantially parallel planes in the closed position;
actuating a fluid actuated piston mounted on one of the frame members, the fluid actuated piston having a locking member that is moved during actuation of the piston; and
receiving the locking member of the fluid actuated piston within a lock receiving portion mounted on the other of the frame members.

15. A method of forming a panel using an apparatus for forming panels, the method comprising the steps of:
arranging the apparatus in an open position;
locating a first skin layer on a first frame member of the apparatus;
locating a second skin layer on a second frame member of the apparatus, wherein the second frame member is movably opposed to the first frame member between the open position and a closed position;
locating one or more seals around the perimeter of the first and second skin layers;
arranging the apparatus in the closed position, wherein the first skin layer and second skin layer each abut the one or more seals to define a cavity therein;
locking the apparatus in the closed position by actuating a fluid actuated piston mounted on one of the frame members, the fluid actuated piston having a locking member that is moved during actuation of the piston, and receiving the locking member of the fluid actuated piston within a lock receiving portion mounted on the other of the frame members;
injecting, a liquid foamable material into the cavity through at least one conduit in the one or more seals;
allowing the liquid foamable material to cure;
unlocking the apparatus by actuating the fluid actuated piston such that the locking member is removed from the lock receiving portion;
moving the apparatus at least partially to the open position; and
removing the panel which includes the first skin layer, second skin layer, and a foam core derived from the cured liquid foamable material.

16. The method of claim 15, wherein the liquid foamable material is a liquid foamable polyurethane.

17. The method of any one of claims 14 to 16, wherein the apparatus is an apparatus for forming panels as claimed in any one of claims 1 to 13.

18. The method of any one of claims 14 to 17, wherein the fluid actuated piston is a hydraulic cylinder and actuation of the hydraulic cylinder causes the cylinder to extend or retract.

19. The method of claim 18, wherein the locking member is a locking pin which is moved to be received by a recess of the lock receiving portion when the hydraulic cylinder is retracted, and is moved out of the recess of the lock receiving portion when the hydraulic cylinder is extended.
